(19) United States
(12) Patent Application Publication
(10) Pub. No.: US 2005/0226446 A1
(43) Pub. Date: Oct. 13, 2005

(54) Intelligent hearing aid

(75) Inventors: Henry Luo, Waterloo (CA); Horst Arndt, Kitchener (CA)

Correspondence Address: BERESKIN AND PARR, 40 KING STREET WEST, BOX 401, TORONTO, ON, M5H 3Y2, CA

(73) Assignee: Unitron Hearing Ltd., Kitchener (CA)

(21) Appl. No.: 10/820,046

(22) Filed: Apr. 8, 2004

(51) Int. Cl. H04R 25/00

(52) U.S. Cl. 381/312; 381/315; 381/318; 381/320

(57) ABSTRACT

A hearing aid that is capable of automatically switching between a full-function mode and a sleep mode depending on the location of the hearing aid. The hearing aid comprises a hearing aid module for processing an input signal and generating a compensated output signal and, a location sensor module for providing a location information signal to indicate one of an in-the-ear case and an out-of-the-ear case. The hearing aid module automatically switches to the full-function mode when the location information signal indicates the in-the-ear case and the hearing aid module automatically switches to the sleep mode when the location information signal indicates the out-of-the-ear case.

### FIELD OF THE INVENTION

The invention relates to hearing aids. More particularly, this invention relates to a hearing aid with associated means for automatically determining when the hearing aid should operate in a full-function mode or in a sleep mode.

### BACKGROUND OF THE INVENTION

Hearing aid users commonly experience acoustic feedback when they insert a hearing aid into or remove a hearing aid from one of their ears since the hearing aid is usually turned on during the insertion or removal process. Further, the feedback that occurs during hearing aid insertion or removal can be annoying and can reduce the comfort level associated with wearing the hearing aid. Sometimes, the hearing aid user can insert the hearing aid into the ear without switching it on. However, if the hearing aid's power switch cannot be located while the aid is in the ear, the hearing aid user has to take the hearing aid out again, switch it on and then reinsert the hearing aid into the ear. This can upset the hearing aid user or at least cause inconvenience.

In addition, it is common for hearing aid users to forget to turn off their hearing aids after removing their hearing aids. This results in a reduction of the battery power of the hearing aid especially if the hearing aid user forgets to turn the hearing aid off at nighttime, in which case battery power is consumed overnight. Accordingly, it is desirable for the hearing aid to be automatically turned on when it is in use and automatically turned off otherwise.

Most hearing aids found in the market today, such as Behind-The-Ear (BTE) and In-The-Ear (ITE) hearing aids, have a power switch to allow the hearing aid user to manually turn the hearing aid on and off at any time. In the cases where the power switch is very small, it is very difficult for the hearing aid user to reach and operate the switch when the hearing aids are being worn. Other hearing aids, such as Completely-In-the-Canal (CIC) or In-The-Canal (ITC) hearing aids, may have no power switch since these hearing aids are so small that it is difficult to install a power switch on the shell. In this case, the battery door may be used as the power switch to operate the hearing aids. Therefore, it is necessary to close the battery door first, while the hearing aid is in the hands of the hearing aid user, before inserting the hearing aid into the hearing aid user's ear. Unfortunately, when the hearing aid is turned on, while being held in the hearing aid user's hand, an open transmission path exists between the microphone and receiver of the hearing aid which will quickly lead to feedback and the production of a squealing sound.

In order to address the feedback problem when the hearing aid is switched on but not yet fully inserted into the ear, some newer digital hearing aids have a “Mute” or delayed start function, which can be programmed during the hearing aid fitting process. Such a feature will let the hearing aid user switch the hearing aid on first and then put the hearing aid into the ear during a preset “mute” or delay time while the output of the hearing aid is attenuated. Accordingly, no feedback will occur. However, the preset “mute” or delay time could be too short in some situations or too long in other situations. For instance, if the hearing aid user becomes otherwise occupied or distracted when the hearing aid user inserts the hearing aid, the hearing aid user may not have enough time to completely insert the hearing aid before the full-function mode is activated. In addition, if the hearing aid user is very old or has impaired movement due to a handicap, the hearing aid user might sometimes require a much longer time to completely insert the hearing aid. Alternatively, when the hearing aid user is in a hurry, he/she may quickly insert the hearing aid and expect it to work immediately. This may happen when the hearing aid user wakes up from sleep to answer a telephone and starts a conversation right away. In this case, a long “mute” or delay time will be not beneficial. In addition, it should be realized that even for the same hearing aid user, a preset “mute” or delay time may not meet all of the different requirements of daily life. Furthermore, the “mute” or delay feature is not useful when the hearing aid is removed from the ear since the “mute” or delay feature does not prevent feedback in this situation before the hearing aid user can turn off the hearing aid.

Regardless of the aforementioned problems (i.e. feedback, comfort level and battery life) related to having to manually turn the hearing aid on and off, it is advantageous to eliminate the power switch from the hearing aid. Eliminating the power switch saves space, simplifies the mechanical design of the hearing aid and reduces the cost of manufacturing. The elimination of the power switch also increases the reliability of the hearing aid since the power switch is a moving mechanical part that is prone to failure over time.

### SUMMARY OF THE INVENTION

The invention provides means for the implementation of an intelligent hearing aid that can determine whether to operate in a full-function mode or in a sleep mode which is an extremely low power consumption mode. The determination is based on whether the hearing aid is in the ear of the hearing aid user (i.e. the in-the-ear case) or out of the ear of the hearing aid user (i.e. the out-of-the-ear case). In the in-the-ear case, the hearing aid operates in full-function mode and in the out-of-the-ear case, the hearing aid operates in sleep mode. This feature of the invention prevents the hearing aid from experiencing feedback when a hearing aid user is inserting the hearing aid since the hearing aid is in sleep mode or when the hearing aid user is removing the hearing aid since the hearing aid will automatically move into sleep mode. Accordingly, the invention increases the comfort level associated with wearing the hearing aid, and allows the hearing aid user to put the hearing aid into the ear and remove the hearing aid from the ear as quickly or as slowly as the hearing aid user wishes without concern for feedback. This is particularly advantageous for older hearing aid users, who may have difficulty in quickly inserting the hearing aid into or quickly removing the hearing aid from their ear to avoid hearing a loud whistling noise due to feedback during the insertion or removal process.

The invention is also advantageous for hearing aid users who often forget to turn their hearing aids off when they remove the hearing aid since the hearing aid will automatically move to sleep mode. This may occur before they go to bed, for example. Accordingly, the invention saves battery life since the hearing aid operates in full-function mode only when it is in use and remains in sleep mode otherwise. The invention also provides a savings in battery life since acoustic feedback does not occur during hearing aid insertion or removal. In addition, the invention advantageously allows for testing the hearing aid in test equipment similar to that used for testing conventional hearing aids. In addition, the invention can be applied to various types of hearing aids such as CIC, ITC, ITE and BTE hearing aids.

In accordance with a first aspect, the invention provides a hearing aid for receiving an input signal and for providing a compensated output signal for a hearing aid user. The hearing aid is capable of automatically switching between a full-function mode and a sleep mode depending on the location of the hearing aid. The hearing aid comprises a hearing aid module for processing the input signal to generate the compensated output signal and, a location sensor module connected to the hearing aid module for providing a location information signal to indicate one of an in-the-ear case and an out-of-the-ear case. The hearing aid module automatically switches to the full-function mode when the location information signal indicates the in-the-ear case and the hearing aid module automatically switches to the sleep mode when the location information signal indicates the out-of-the-ear case.

In accordance with a second aspect, the invention provides a method for switching modes of operation in a hearing aid, wherein the hearing aid is capable of automatically switching between a full-function mode and a sleep mode depending on the location of the hearing aid. The method comprises:
a) providing a polling signal for determining the location of the hearing aid;
b) generating a location information signal after the polling signal is first provided, the location information signal indicating one of an in-the-ear case and an out-of-the-ear case; and,
c) automatically switching to the full-function mode if the location information signal indicates the in-the-ear case and automatically switching to the sleep mode if the location information signal indicates the out-of-the-ear case.

### BRIEF DESCRIPTION OF THE DRAWINGS

For a better understanding of the present invention and to show more clearly how it may be carried into effect, reference will now be made, by way of example only, to the accompanying drawings which show an exemplary embodiment of the present invention and in which:

FIG. 1 is a simplified block diagram of an exemplary embodiment of a hearing aid having a location sensor module for providing information about the location of the hearing aid in accordance with the invention;

FIG. 2a is an exemplary schematic of the location sensor module of FIG. 1;

FIG. 2b is a timing diagram associated with the location sensor module of FIG. 2a;

FIG. 2c illustrates the light signal paths for the in-the-ear case for an exemplary embodiment of the emitter, detector and optical window;

FIG. 2d illustrates the light signal paths for the out-of-the-ear case for an exemplary embodiment of the emitter, detector and optical window;

FIG. 3a is another exemplary embodiment of the location sensor module of FIG. 1;

FIG. 3b is a timing diagram associated with the location sensor module of FIG. 3a;

FIG. 4 is a flowchart of a processing methodology for an intelligent hearing aid in accordance with the invention;

FIG. 5a is an illustration of a BTE intelligent hearing aid showing the location of an optical window of the location sensor module in accordance with the invention;

FIG. 5b is an illustration of the BTE intelligent hearing aid of FIG. 5a in a normal sitting position in the out-of-the-ear case;

FIG. 6a is an illustration of an ITE intelligent hearing aid showing the location of an optical window of the location sensor module in accordance with the invention;

FIG. 6b is an illustration of the ITE intelligent hearing aid of FIG. 6a in a normal sitting position in the out-of-the-ear case;

FIG. 7a is an illustration of an ITC/CIC intelligent hearing aid showing the location of an optical window of the location sensor module in accordance with the invention; and,

FIG. 7b is an illustration of the ITC/CIC intelligent hearing aid of FIG. 7a in a normal sitting position in the out-of-the-ear case.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures and components have not been described in detail so as not to obscure the invention. Further, it should be understood that there are many variations of hearing aids because of variations in input channels, program switches, etc. Accordingly, exemplary embodiments of hearing aids in accordance with the invention are shown and described but are not meant to limit the invention.

A hearing aid in accordance with the invention is referred to as an intelligent hearing aid because the hearing aid has a location sensor module for determining the location of the hearing aid. Based on the location information, the hearing aid automatically operates in either a full-function mode or a sleep mode in which there is very low power consumption. The intelligent hearing aid operates in full-function mode when the location information indicates that the hearing aid is in the ear of the hearing aid user. Conversely, the intelligent hearing aid operates in sleep mode when the location information indicates that the hearing aid is not in the ear of the hearing aid user.

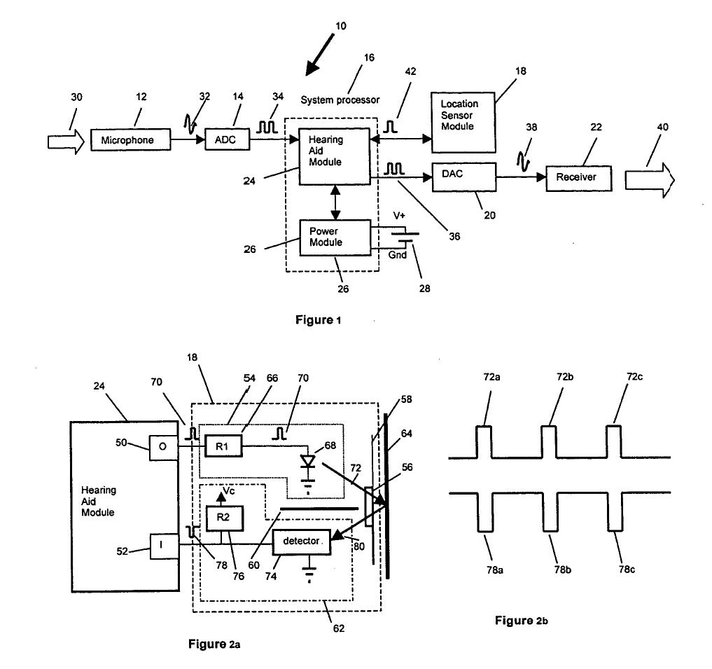

Referring first to FIG. 1, shown therein is a simplified block diagram of an exemplary embodiment of an intelligent hearing aid 10 in accordance with the invention. The hearing aid 10 comprises an acoustic sensor 12, an analog-to-digital converter (ADC) 14, a system processor 16, a location sensor module 18, a digital-to-analog converter (DAC) 20 and a receiver 22 connected as shown in FIG. 1. If the receiver 22 is a zero-bias receiver then the DAC 20 may be omitted. The system processor 16 includes a hearing aid module 24 and a power module 26 with voltage V and ground inputs GND connected to a battery 28. The system processor 16 and its components may be implemented using a digital signal processor, and/or discrete electronic components, as is well known to those skilled in the art.

Alternative implementations of the hearing aid 10 can include other input means such as multiple microphones, an induction pick-up coil and a direct electrical input, or a bone conduction output as is well known to those skilled in the art. For simplicity, this description focuses on a single microphone input.

In use, when the hearing aid 10 is in full-function mode, the microphone 12 receives an acoustic input sound signal 30 and provides a corresponding analog input signal 32. The acoustic input sound signal 30 contains desirable audio information and noise. The microphone 12 may be any type of sound transducer capable of receiving a sound signal and providing a corresponding analog electrical signal. The ADC 14 receives the analog input signal 32 and produces a digital input signal 34. The digital input signal 34 is then processed by the hearing aid module 24 to produce a digital output signal 36. The output signal 36 can be considered to be a compensated output signal wherein the compensation is related to the hearing loss of the hearing aid user. Accordingly, the hearing aid module 24 may perform several functions on the digital input signal 34 such as amplification, adaptive noise filtering, compression, feedback cancellation, operating under various modes such as microphone mode or tele-coil mode and the like. These operations are well known to those skilled in the art. The digital output signal 36 is then converted to an analog output signal 38 by the DAC 20 and transduced by the receiver 22 to produce an output signal 40 that is presented to the user of the hearing aid 10.

In general, the location sensor module 18 and the hearing aid module 24 communicate via a bi-directional information signal 42. The hearing aid module 24 polls the location sensor module 18 via the bi-directional signal 42, on preferably a periodic basis, to determine whether the hearing aid 10 is in the ear of the hearing aid user. In this case, the bi-directional signal 42 acts as a polling signal. In response to polling done via the bi-directional information signal 42, the location sensor module 18 probes the outer environment of the hearing aid 10 and returns location information via the bi-directional location signal 42. In this case, the bi-directional signal 42 acts as a location information signal. If the location information indicates that the hearing aid 10 is in the ear of the hearing aid user (i.e. the in-the-ear case), the hearing aid 10 operates in full-function mode. If the location information indicates that the hearing aid 10 is not in the ear of the hearing aid user (i.e. the out-of-the-ear case), the hearing aid 10 operates in sleep mode. In sleep mode, the hearing aid 10 can essentially be considered to be off.

There are several general scenarios for the location of the hearing aid. In the first scenario, the hearing aid 10 is not in the ear of the user and the hearing aid 10 and is in sleep mode. In this case, the location sensor module 18 is polled and the location information indicates that the hearing aid 10 is not in the ear of the hearing aid user and the hearing aid 10 continues to operate in sleep mode. In the second scenario, the hearing aid 10 has just been inserted into the ear of the hearing aid user and the hearing aid 10 was previously in sleep mode. In this case, the location sensor module 18 is polled and the location information indicates that the hearing aid 10 is in the ear of the hearing aid user. The hearing aid 10 then moves into full-function mode. In the third scenario, the hearing aid 10 is in full-function mode and is being taken out of the ear of the hearing aid user. The location sensor module 18 is polled and the location information indicates that the hearing aid 10 is no longer in the ear of the hearing aid user. The hearing aid 10 then moves into sleep mode.

The invention generally relies on shining light having a particular wavelength on human skin as well as the reflectance properties of human skin. The surface reflection of the human skin occurs at the surface of the epidermis and is approximately independent of the lighting wavelength and independent of human race. In the infrared (IR) range the wavelengths that can be used are greater than 800 nano-meters and the surface reflectance of human skin is more or less constant and close to 50%. The same hold true for orange and red light in the visible light range, namely wavelengths between approximately 600 and 800 nano-meters can be used, although the surface reflectance for darker skin is reduced for shorter wavelengths. Surface reflectance for dark skin is approximately 25% at 700 nano-meters. In the embodiments shown herein, the energy of choice in the sensor unit 18 is preferably infrared (IR) energy. However, long wavelength visible light energy can also be used as discussed below.

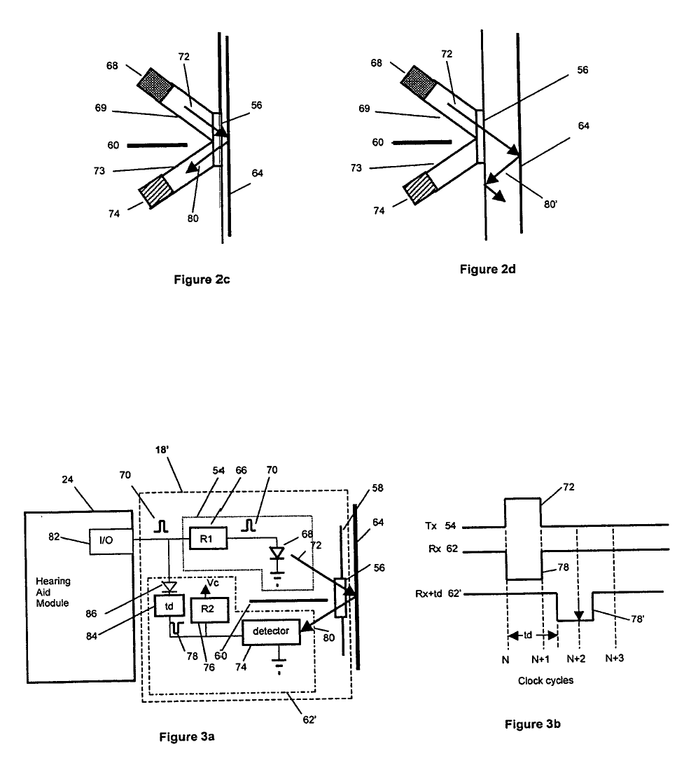

Referring now to FIG. 2a, shown therein is an exemplary schematic of the location sensor module 18. In this case, the hearing aid module 24 has an output port 50 and an input port 52. The location sensor module 18 has a transmission unit 54 that is connected to the output port 50, an optical window 56 located on a portion of the shell 58 of the hearing aid 10, a blocking member 60, and a reception unit 62 that is connected to the input port 52. The transmission unit 54 emits IR energy preferably in the form of a series of pulses through the optical window 56. If the hearing aid 10 is in the ear of the hearing aid user then the skin 64 of the hearing aid user will reflect the IR energy back through the optical window 56 to the reception unit 62. The skin 64 may be the skin of the outer portion of the hearing aid user's pinna if the hearing aid 10 is a BTE hearing aid. Alternatively, the skin 64 may be the skin of the hearing aid user's concha or external auditory meatus if the hearing aid 10 is an ITE/ITC/CIC hearing aid.

The optical window 56 is placed at a certain location on the shell 58 of the hearing aid 10. The location of the optical window 56 depends on whether the hearing aid is a BTE, ITE, ITC or CIC hearing aid. In addition, the location is chosen to minimize the distance between the optical window 56 and the skin 64. For optimal reflection of IR signals back through the optical window, the hearing aid user's skin (i.e. the reflecting surface) is required to be immediately over the optical window 56; otherwise the reflected IR energy will not be reflected back towards the reception unit 62. The optical window 56 is typically a small window having a diameter of approximately 1 mm for example. The optical window 56 can be made from IR grade glass or other suitable material that allows for the passage of infrared energy (a different material would be used if visible light is used rather than infrared light). The optical window 56 should be kept clean at all times in order to prevent the emitted infrared energy from being reflected back due to dirt and the like that may accumulate on the optical window 56 over time. The location of the optical window 56 will be discussed in further detail below.

The blocking member 60 is mounted in the location sensor module 18 to ensure that the IR energy that is emitted by the transmission unit 54 is not directly transmitted to the reception unit 62. Accordingly, the blocking member 60 is made from material that does not transmit IR energy.

The transmission unit 54 comprises at least a resistor 66 and a light emitter 68 that emits light in the visible light range or the IR light range. In this exemplary embodiment, the emitter 68 is an IR emitting diode (i.e. an IR LED). One node of the resistor 66 is connected to the output port 50 and the other node of the resistor 66 is connected to the emitter 68. The other node of the emitter 68 is connected to ground. The resistor 66 limits the current through the emitter 68. In general, any current limiting network can be used in place of the resistor 66. However, it is preferable to use a resistor for low-power consumption. The value of the resistor 66 depends on the internal resistance of the emitter 68 and the impedance of and voltage at the output port 50 of the hearing aid module 24.

The transmission unit 54 receives a polling signal 70 from the output 50 of the hearing aid module 24. The polling signal 70 is preferably a signal pulse that has a high logic level (i.e. a binary 1) when the hearing aid module 24 wants to determine whether the hearing aid 10 is in the ear of the hearing aid user. The resistance of the resistor 66 is such that polling signal 70′ has a sufficient amplitude to cause the emitter 68 to emit an IR emission signal 72. The emitter 68 is positioned so that the IR emission signal 72 is directed through the optical window 56 at an oblique angle of incidence. After the IR emission signal 72 goes through the optical window 56, the IR emission signal 72 is reflected back through the optical window towards the detector 74 if the optical window 56 is close to skin 64, or another IR reflecting surface. Otherwise, the IR emission signal 72 is not reflected back towards the detector 74. The latter condition indicates that the hearing aid 10 is not in the ear of the hearing aid user.

The reception unit 62 comprises at least a low power detector 74 and a resistor 76. In this exemplary embodiment, the detector 74 is an IR optical transistor. Either a BJT or a FET optical transistor can be used, the preference being that the transistor consumes little power. Alternatively, the detector may be an IR photodiode. If the detector 74 is a BJT, then the resistor 76 is connected to the collector of the detector 74, the emitter of the detector 74 is connected to ground and the base of the detector 74 is floating. If the detector 74 is a FET, the gate is floating, the drain is connected to the resistor 76 and the source is connected to ground. Further, the detector 74 is positioned with respect to the optical window 56 to receive a reflected version of the IR emission signal 72. The IR detector 74 may be positioned in a symmetrical fashion to the IR emitter 68. The voltage Vc is provided by the power module 26 or another suitable component as is commonly known by those skilled in the art. The resistor 76 limits the current through the detector 74 when the received IR signal turns on the optical transistor. Also, the influence of naturally occurring steady state IR energy in the ear can be eliminated by biasing the detector 74 at a level such that the detector 74 only turns on when it detects IR energy that is higher than the amount of ambient IR energy.

The detector 74 provides a location information signal 78 to the input port 52 of the hearing aid module 24. In this exemplary embodiment, the location information signal 78 is a constant signal which is typically at a high logic level (i.e. a binary 1) when no IR signal is being received by the detector 74. However, when the IR emission signal 72 is reflected by the skin 64 to the reception unit 62, the detector 74 receives a reflected IR signal 80. This causes the detector 74 to produce a low logic level pulse (i.e. a binary 0) on the location information signal 78. This provides an indication to the hearing aid module 24 that the hearing aid 10 is in the ear of the hearing aid user and that the hearing aid 10 should be operating in full-function mode. Otherwise, the location information signal 78 is constantly at a high logic level.

The hearing aid module 24 can process the location information signal 78 in a few different ways. The hearing aid module 24 can move into full-function mode after a time normally required to “start-up” processing once the location information signal 78 transitions to a low logic level from a high logic level during polling. Likewise, the hearing aid module 24 can move into sleep mode within an associated “shut-down” processing time when the location information signal 78 remains in a high logic level during polling.

Referring now to FIG. 2b, shown therein is a timing diagram associated with the location sensor module 18. The IR emission signal 72 is a series of pulses 72a, 72b and 72c. The low logic level states in the location information signal 78 that signify that the hearing aid 10 is in the ear of the hearing aid user are represented by pulses 78a, 78b and 78c. Only three pulses and three low level logic states have been shown for simplicity. The IR emission signal 72 may comprise more or less than three pulses and there may be a comparable number of transitions in the location information signal 78 depending on whether the hearing aid module 10 is in the ear of the hearing aid user. A detection is defined when the low logic level state in the location information signal 78 reaches a specific level. There may also be other detection schemes which require more than one transition in the location information signal 78 in order to avoid false detection due to spurious signals.

As shown in FIG. 2b, the IR emission signal 72 has a certain duration to allow the hearing aid module 24 to read the values provided in the location information signal 78. Typically, the pulse duration of an IR emission signal 72 will be a short period, e.g. two clock cycles of the system processor 16. In this case, the duration of a pulse in the IR emission signal 72 can be as short as 1 microsecond if the system clock is operating at 2 MHz. However, the period of the pulses in the IR emission signal 72 can be lower at higher clock frequencies. The low level logic state due to the reflected IR energy appears almost instantaneously at the input port 52, and is sampled on the clock cycle (N+1) that occurs after the clock cycle (N) during which emission began. Accordingly, both the high logic level at the output port 50 and the low logic level at the input port 52 have a duration of approximately two clock cycles. Accordingly, the location sensor module 18 consumes minimal power in sleep mode since the module 18 will only work for about 0.001% of the time given a system clock speed of 2 MHz. Further, in sleep mode all analog circuits including the microphone 12, ADC 14, DAC 24 and the receiver 22 are turned off. Only a small portion of the digital circuitry of the hearing aid 10 functions and the circuitry that does function operates in an extremely low power mode to save battery power.

In both of the transition scenarios, i.e. from full-function mode to sleep mode, or from sleep mode to full-function mode, the hearing aid module 24 can perform more intelligent processing on the location information signal 78 to ensure that the location information signal 78 is providing reliable information and is not being influenced by environmental noise or other forms of interference. For example, body heat is not a problem since inadvertent triggering of the detector 74 due to ambient IR energy radiated from the human body can be prevented by correctly biasing the detector 74, thereby rendering the detector 74 immune to a background IR energy level. In addition, the influence of transient high level IR signals can be eliminated by requiring a high logic state at the output port 50 and the input port 52 to be present simultaneously. Further, temperature change in body heat is not problematic since the temperature in the ear (or behind the ear) changes over a relatively small range.

Referring now to FIGS. 2c and 2d, shown therein is a more detailed embodiment of the spatial relationship between the emitter 68, the optical window 56, the detector 74, and the skin 64 of the hearing aid user or another light reflecting surface. The emitter 68 is positioned so that the signal 72 from the emitter 68 is beamed down an enclosed channel 69 towards the optical window 56. For the in-the-ear case shown in FIG. 2c, the skin 64 is immediately next to the optical window 56 and reflects the emitted signal 72 back into a second channel 73 towards the detector 74. FIG. 2d shows the out-of-the-ear case in which the skin 64 is at some distance removed from the optical window 56. In this case, the reflected beam 80′ misses the optical window 56. The detector 74 does not receive the reflected signal 80′ and remains in a high logic level state thereby signaling the out-of-the-ear case. FIGS. 2c and 2d also show that the emitter 68 and the detector 74 are placed at complementary angles with respect to one another, i.e., the angle that the longitudinal axis of the emitter 68 makes with respect to the blocking member 60 is substantially similar to the angle that the longitudinal axis of the detector 74 makes with respect to the block member 60 since the angle of incidence of the emission signal 72 is the same as the angle of reflection of the reflected signal 80. The blocking member 60 can consist of a discrete light barrier shown in FIG. 2c and FIG. 2d. Alternatively, the material making up the walls of channels 69 and 73 or the material between channels 69 and 73 can constitute the blocking member 60 if these materials do not transmit visible or IR light.

Referring now to FIG. 3a, shown therein is another exemplary embodiment of a location sensor module 18′. Similar reference numerals are used to represent elements that are similar to those of the location sensor module 18. This embodiment preferably uses IR signals to distinguish between the in-the-ear case and the out-of-the-ear case. However, certain wavelengths of visible light may also be used as previously described. In some system processors, the available I/O ports may be limited. Accordingly, there may be only one I/O port available for the location sensor module 18′. In this case, the hearing aid module 24 only uses one I/O port 82 and communicates via bidirectional signal 42 for both sending the polling signal 70 to the transmission unit 54 and receiving the location information signal 78 from the reception unit 62′. To facilitate this bi-directional communication scheme, the reception unit 62′ includes a delay unit 84 and a transmission gate 86. One node of the time delay unit 84 is connected to the collector or drain of the detector 74 (depending on whether a BJT or a FET is used) and the other node of the delay unit 84 is connected to one of the nodes of the transmission gate 86. The other end of the transmission gate 86 is connected to the I/O port 82. In alternative embodiments, the delay unit 84 may be placed in the transmission unit 54 or may be placed in both the transmission unit 54 and the reception unit 62.

In use, the hearing aid module 24 first configures the I/O port 82 as an output port and sends the polling signal 70 to drive the emitter 68 to emit the IR emission signal 72. After an appropriate delay, the hearing aid module 24 will configure the I/O port 82 to be an input port to receive the location information signal 78. The delay provided by the delay unit 84 is preferably on the order of 1 to 2 system clock cycles (i.e. approximately 0.5 to 1 microseconds if the system clock runs at 2 MHz) to allow the hearing aid module 24 to reconfigure the I/O port 82 as an input port. A typical delay that may be used is 1.5 cycles.

The transmission gate 86 blocks the location information signal 78 from the I/O port 82 and the transmission unit 54 when the I/O port 82 is configured to operate as an output port. Alternatively, when the I/O port 82 is configured to operate as an input port, the transmission gate 86 transmits the location information signal 78′ to the I/O port 82. In this exemplary embodiment, the transmission gate 86 is a diode. Accordingly, prior to the emission of an IR pulse by the emitter 68, the polling signal 70 has a low logic value, there is no IR energy emitted and the location information signal 78 has a high logic value, In this case, the diode 86 is reverse biased, will not conduct current and will isolate the transmission unit 54 from the high logic value of the location information signal 78. However, during the transmission of an IR pulse, the polling signal 70 has a high logic value and IR energy is transmitted by the emitter 68. For the in-the-ear case, the IR energy reflects, the detector 74 receives the reflected IR signal 80 and the location information signal 78 transitions to the low logic level. In this case, the diode 86 is forward biased, after an appropriate delay, and will conduct current thereby allowing the I/O port 82 to sense the transition to a low logic level on the location information signal 78′. After the hearing aid module 24 reads the I/O port 82, the hearing aid module 24 will reconfigure the I/O port 82 to be an output port and will provide a low logic value for the polling signal 70.

Referring now to FIG. 3b, shown therein is a timing diagram associated with the location sensor module 18′. The first line of the timing diagram shows the IR emission signal 72 that is emitted by the transmitter 68 at clock cycle N. This case shows an example in which the duration of the IR emission signal 72 is only 1 clock cycle. For the embodiment of the location sensor module 18′, the response encoded in the information signal 78 occurs almost instantaneously and lasts for the same clock cycle duration. However, for the embodiment of the location sensor module 18′, the response 78 is delayed by a time td such that the response is encoded in the information signal 78′ during the N+1 and N+2 clock cycles. The response is actually detected by the hearing aid module 24 at clock cycle N+2 (as represented by the arrow).

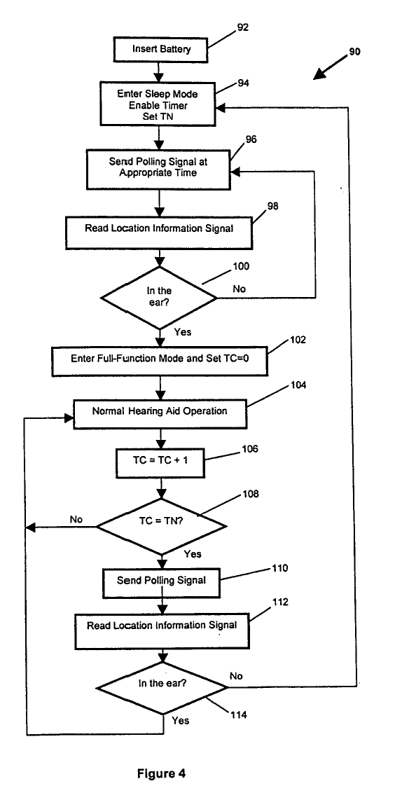

Referring now to FIG. 4, shown therein is a flowchart of a processing methodology 90 for an intelligent hearing aid in accordance with the invention. The processing methodology 90 starts at step 92 in which the battery 28 is first inserted. The hearing aid module 24 then initializes the hearing aid 10 in step 94 and the hearing aid 10 enters sleep mode. Sleep mode involves turning all unneeded circuitry and hearing aid processing off. In sleep mode, the hearing aid module 24 also sets an enable timer or a watchdog circuit to create an interrupt at a predetermined time. The majority of the hearing aid 10 operates in sleep mode during the interrupt process. If a time constant TN of 0.1 seconds is used, for example, to create the interrupt, then the portion of the hearing aid module 24 associated with polling will “wake-up” to send a high logic level on the polling signal 70 in step 96 and read the location information signal 78 in step 98. The total duration of steps 96 and 98 will be very short, approximately 2 clock cycles, for example. In step 100, the hearing aid module 24 determines whether the hearing aid 10 is in the ear of the hearing aid user. If the determination is negative, the process 90 will go back to step 96 and wait for the next interrupt to occur. Accordingly, as long as the hearing aid 10 is not in the ear of the hearing aid user, the hearing aid 10 will consume very little battery power and no feedback will occur.

If the hearing aid module 24 determines that the hearing aid is in the ear of the hearing aid user in step 100, then the process 90 moves to step 102 in which the hearing aid 10 moves into full-functional mode and the circuitry of the hearing aid 10 is fully enabled after a time delay normally associated with the startup time of the system processor to reach normal hearing aid operation. This ensures that the hearing aid 10 is fully positioned in the ear. At this point, a time counter TC is set to 0. The time counter TC is implemented via a dedicated service routine or an internal time counter. The next step 104 is for the hearing aid to function as it normally would. During full-function mode, the time counter TC is updated in step 106 and the hearing aid module 24 checks to see whether the counter TC has reached the time constant TN in step 108. If not, the hearing aid 10 continues to operate in full-function mode. However, once the time counter TC reaches the time constant TN, the hearing aid module 24 sends the polling signal 70 in step 110 and reads the location information signal 78 in step 112. Alternatively, a preprogrammed timer interrupt can be used instead of time constant TN.

If it is determined in step 114 that the hearing aid 10 is still in the ear of the hearing aid user, then the process moves to step 104 and the hearing aid module 24 resets the counter TC and waits for the next time interrupt to occur. However, it if is determined in step 114 that the hearing aid 10 is no longer in the ear of the hearing aid user, the process moves to step 94 in which the hearing aid module 24 turns off all analog circuits and hearing aid processing, sets the timer interrupt or watchdog circuit with a wait time TN and the hearing aid 10 enters sleep mode.

The hearing aid 10 can poll the location sensor module 18 on a periodic basis as is described above. However, the interrupt frequency can be varied under different circumstances. For instance, if the hearing aid 10 is in full-function mode, it can be likely that the hearing aid 10 will continue to operate in full-function mode for a while. In this case, the interrupt frequency can be decreased. An “InEar” timer can keep track of the amount of time that the hearing aid 10 is in the ear of the hearing aid user. Once the InEar timer indicates that the hearing aid 10 has been in the ear for a certain time duration, such as 14 hours for example, it can be expected that the hearing aid user will soon be removing the hearing aid 10. In this case, the interrupt frequency can be increased.

Conversely, when the hearing aid 10 is in sleep mode, it can be likely that the hearing aid 10 will continue to operate in sleep mode for a while. In this case, the interrupt frequency can be decreased. Similarly to the in-the-ear case, an “OutofEar” timer can keep track of the amount of time that the hearing aid 10 is out of the ear of the hearing aid user. Once the OutofEar timer indicates that the hearing aid 10 has been out of the ear for a certain time duration, such as 6 hours for example, it can be expected that the hearing aid user will soon be inserting the hearing aid 10. In this case, the interrupt frequency can be increased.

Referring now to FIG. 5a, shown therein is an illustration of a BTE intelligent hearing aid 120 showing the location of the optical window 56 in accordance with the invention. In general the optical window 56 can be placed along the inner surface 122 of the BTE hearing aid 120. However, it is preferable to place the optical window 56 on the upper inner surface 122u of the BTE hearing aid 120 where the BTE hearing aid 120 fits snugly against the outside of the hearing aid user's ear when the BTE hearing aid 120 is worn. The optical window 56 is preferably located such that it is as close as possible to the skin of the hearing aid user during the in-the-ear condition. Of course, it should be understood that the BTE intelligent hearing aid 120 is not placed inside the ear and so the in-the-ear case simply means that the BTE intelligent hearing aid 120 is being worn by the hearing aid user.

FIG. 5b shows the BTE intelligent hearing aid 120 in a normal sitting position for the out-of-the-ear case. The inner surface 122 where the optical window 56 is located is facing horizontally almost parallel with the surface upon which the hearing aid 120 is sitting. Accordingly, the optical window 56 is “open”, there is no reflection of IR energy back to the optical window 56 and the hearing aid 120 is in sleep mode.

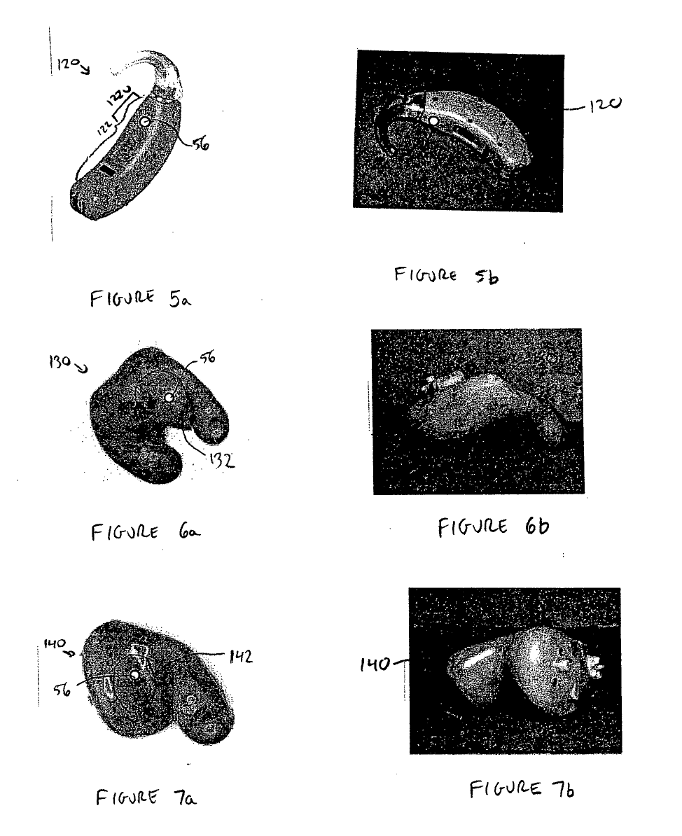

Referring now to FIG. 6a, shown therein is an illustration of an ITE intelligent hearing aid 130 showing the location of the optical window 56 in accordance with the invention. In general the optical window 56 can be placed on the surface of a region 132 which matches the shape (i.e. concave or convex) of the concha or external auditory meatus in a complementary fashion to provide a snug, comfortable fit for the hearing aid user. This location ensures that the optical window 56 is against the skin of the hearing aid user when the hearing aid 130 is being worn.

FIG. 6b shows the ITE intelligent hearing aid 130 of FIG. 6a in a normal sitting position for the out-of-the-ear case. The region 132 where the optical window 56 is located is facing downwards and there is a large gap 134 between the optical window 56 and the surface upon which the hearing aid 130 is sitting. Accordingly, the optical window 56 is “open”, there is no reflection of IR energy back to the optical window 56 and the hearing aid 130 is in sleep mode. In this case, since the reflecting surface is not located immediately next to the optical window 56, the reflected IR energy will miss the optical window 56 and therefore not reach the detector 74. The basic cylindrical window shape can be further refined to ensure that only reflecting surfaces immediately on top of the optical window 56 will trigger a response from the detector 74. For example a truncated cone shape with the smaller diameter facing out can be used.

Referring now to FIG. 7a, shown therein is an illustration of an ITC/CIC intelligent hearing aid 140 showing the location of the optical window 56 in accordance with the invention. Once again, the optical window 56 is located on the surface of a region 142 of the hearing aid 140 that matches the shape of the concha or external auditory meatus in a complementary fashion to provide a snug, comfortable fit for the hearing aid user. This location ensures that the optical window 56 is against the skin of the hearing aid user when the hearing aid 140 is being worn.

FIG. 7b shows the ITC/CIC intelligent hearing aid 140 of FIG. 7a in a normal sitting position for the out-of-the-ear case. The region 142 where the optical window 56 is located is facing downwards at an angle and there is a large gap 144 between the optical window 56 and the surface upon which the hearing aid 140 is sitting. Accordingly, the optical window 56 is “open”, there is no reflection of IR energy back to the optical window 56 and the hearing aid 140 is in sleep mode.

For each of the BTE hearing aid 120, ITE hearing aid 130 and the ITC/CIC hearing aid 140, the optical window 56 is “open” when each of the hearing aids 120, 130 and 140 is not in the ear, such as when each of the hearing aids 120, 130 and 140 is put on a table, in the hand or in a drawer. In these cases, the hearing aids 120, 130 and 140 will be in sleep mode. Furthermore, when the hearing aids 120, 130 and 140 are put into a storage container for storage while not in use, the hearing aids 120, 130 and 140 are unlikely to switch into full-function mode since the optical window 56 will not be directly against an inner surface of the storage container. Conversely, the optical window 56 is “blocked” when the hearing aids 120, 130 and 140 are worn by the hearing aid user since the optical window 56 will be against the hearing aid user's skin. In this case, the hearing aids 120, 130 and 140 will be in full-function mode.

While the intelligent hearing aids of the invention are in full-function mode only when the hearing aid is being worn by the hearing aid user, it is still possible to conduct product tests and performance verification on the intelligent hearing aids as is conventionally done with all hearing aids. These tests may involve putting the intelligent hearing aids in a test box. During testing, a piece of tape, a sticker, or any other material that reflects IR energy can be used to cover the optical window 56. In this case, the intelligent hearing aid will be operating in full-function mode.

In an alternative embodiment, as previously mentioned, visible light and a plain glass window may be used rather than IR light. In this case, the emitter and the detector are photo-electronic elements that can generate and detect light, respectively, in the visible light spectrum. Further, the blocking member is made of a material that blocks the passage of visible light. The remainder of the structure of the location sensor module is as described for location sensor module 18 or location sensor module 18′. However, in this embodiment, the hearing aid module behaves slightly differently. For instance, the hearing aid module can simply poll the detector for the presence of visible light without having the emitter emit visible light. If visible light is detected, then the hearing aid is out of the ear and the hearing aid is put into sleep mode. If visible light is not detected, then the hearing aid is either in the ear or out of the ear but in a dark room or in a box. The hearing aid then goes into a polling mode in which the emitter emits visible light at a certain period such as 0.1 s. If the detector detects visible light after the emitter emits visible light (similar to the IR case), the hearing aid is in the ear and the hearing aid operates in full-function mode. If the detector does not detect visible light in this case, the hearing aid is out of the ear and the hearing aid operates in sleep mode. In this alternative embodiment, ambient light is ignored by setting an appropriate threshold in the detector.

It should be understood by those skilled in the art that, for each embodiment of the hearing aid shown herein, the detector applies a first level of detection criteria to the received light signal to determine if the light signal is ambient infrared light or a truly reflected IR light signal or a visible light signal. In all cases, the hearing aid module may apply a second set of detection criteria, such as requiring two or more consecutive transitions on the location information signal so that transient or spurious light signals do not cause a false detection.

It should be understood that various modifications can be made to the embodiments described and illustrated herein, without departing from the present invention, the scope of which is defined in the appended claims.

1. A hearing aid for receiving an input signal and for providing a compensated output signal for a hearing aid user, wherein the hearing aid is capable of automatically switching between a full-function mode and a sleep mode depending on the location of the hearing aid, the hearing aid comprising:
a) a hearing aid module for processing the input signal to generate the compensated output signal; and,
b) a location sensor module connected to the hearing aid module for providing a location information signal to indicate one of an in-the-ear case and an out-of-the-ear case;
wherein, the hearing aid module automatically switches to the full-function mode when the location information signal indicates the in-the-ear case and the hearing aid module automatically switches to the sleep mode when the location information signal indicates the out-of-the-ear case.

2. The hearing aid of claim 1, wherein the location sensor module comprises:
a) a transmission unit for generating a light emission signal in response to a polling signal provided by the hearing aid module;
b) an optical window located on a shell of the hearing aid for allowing the light emission signal to pass out of the location sensor module and a corresponding reflected light signal to pass into the location sensor module;
c) a reception unit for receiving the reflected light signal and generating the location information signal; and,
d) a blocking member placed between the transmission unit and the reception unit for optically blocking the light emission signal from the reception unit;
wherein, during the transmission of the light emission signal, the location information signal is adapted to indicate the in-the-ear-case if the light reflected signal is received according to reception criteria and the location information signal is adapted to indicate the out-of-the-ear case otherwise.

3. The hearing aid of claim 2, wherein the transmission unit includes a light emitter for generating the light emission signal and the reception unit comprises a light detector for detecting the reflected light signal, wherein the light emitter and light detector are directed towards the optical window at a complementary angle with respect to one another and the blocking member is located between the light emitter and the light detector.

4. The hearing aid of claim 2, wherein the light emission signal and the reflected light signal is a visible light signal.

5. The hearing aid of claim 4, wherein the visible light signal has a wavelength of between approximately 600 and 800 nanometers.

6. The hearing aid of claim 2, wherein the light emission signal and the reflected light signal is an infrared light signal.

7. The hearing aid of claim 6, wherein the infrared light signal has a wavelength greater than approximately 800 nanometers.

8. The hearing aid of claim 2, wherein the reception unit is biased at a minimum voltage whereby the reception unit does not generate a response due to ambient light.

9. The hearing aid of claim 2, wherein the transmission unit comprises:
a) a resistor connected to an output port of the hearing aid module; and,
b) an emitter connected to the resistor and ground, the emitter being placed in a direction towards the optical window and driven to emit the light emission signal in response to the polling signal.

10. The hearing aid of claim 2, wherein the reception unit comprises:
a) a resistor connected to an input port of the hearing aid and to a supply voltage; and,
b) a detector connected to the input port of the hearing aid and ground, the detector being placed in a direction towards the optical window.

11. The hearing aid of claim 2, wherein the hearing aid module comprises an input/output port, the transmission unit and the reception unit are both connected to the input/output port, at least one of the reception unit and the transmission unit includes a time delay element and wherein the reception unit includes a transmission gate for isolating the reception unit from the hearing aid module when the hearing aid module transmits the polling signal to the transmission unit, and the transmission gate connects the reception unit to the hearing aid module, after an appropriate delay provided by the time delay unit, when the reflected light signal is received by the reception unit.

12. The hearing aid of claim 11, wherein the transmission unit comprises:
a) a resistor connected to the input/output port of the hearing aid module; and,
b) a light emitter connected to the resistor and ground, the light emitter being placed in a direction towards the optical window and driven to emit the light emission signal in response to the polling signal.

13. The hearing aid of claim 11, wherein the transmission gate is connected to the input/output port and the reception unit further comprises:
a) the time delay unit connected to the transmission gate;
b) a resistor connected to the time delay unit and to a supply voltage; and,
c) a detector connected to the time delay unit and ground, the detector being placed in a direction towards the optical window.

14. The hearing aid of claim 2, wherein the hearing aid is a behind-the-ear hearing aid and the optical window is placed on an inside surface of the behind-the-ear hearing aid.

15. The hearing aid of claim 2, wherein the hearing aid is one of an in-the-ear hearing aid, an in-the-canal hearing aid and a completely-in-the-canal hearing aid, and in each case, the optical window is placed on a portion of the hearing aid shaped to match the shape of a portion of the concha or the inner auditory meatus of the hearing aid user in a complementary fashion.

16. The hearing aid of claim 1, wherein the location sensor module comprises:
a) an optical window located on a shell of the hearing aid for allowing a visible light signal to pass therethrough; and,
b) a reception unit for receiving the visible light signal and generating a detection event in the location information signal in response to polling provided by the hearing aid module
wherein, the location information signal is adapted to indicate the out-of-the-ear-case if visible light is detected according to reception criteria.

17. The hearing aid of claim 16, wherein the location sensor module further comprises:
a) a transmission unit for generating a visible light emission signal in response to a polling signal provided by the hearing aid module, the transmission unit being positioned to direct the visible light emission signal though the optical window; and,
b) a blocking member placed between the transmission unit and the reception unit for optically blocking the visible light emission signal from the reception unit;
wherein, if the reception unit does not detect visible light, the transmission unit is polled to generate a visible light emission signal, and the location information signal is adapted to indicate the in-the-ear-case if a visible light reflected signal, derived from the visible light emission signal, is received according to reception criteria and the location information signal is adapted to indicate the out-of-the-ear case otherwise.

18. A method for switching between modes of operation in a hearing aid, wherein the hearing aid is capable of automatically switching between a full-function mode and a sleep mode depending on the location of the hearing aid, the method comprising:
a) providing a polling signal for determining the location of the hearing aid;
b) generating a location information signal after the polling signal is first provided, the location information signal indicating one of an in-the-ear case and an out-of-the-ear case; and,
c) automatically switching to the full-function mode if the location information signal indicates the in-the-ear case and automatically switching to the sleep mode if the location information signal indicates the out-of-the-ear case.

19. The method of claim 18, wherein step (a) includes:
a) generating a light emission signal in response to the polling signal; and,
b) transmitting the light emission signal out of an optical window located on a shell of the hearing aid.

20. The method of claim 19, wherein step (b) includes:
a) generating a first value in the location information signal if a reflected light signal is received via the optical window according to reception criteria, the first value indicating the in-the-ear case; and,
b) otherwise generating a second value in the location information signal, the second value indicating the out-of-the-ear case.

21. The method of claim 19, wherein the method includes providing a visible light signal for the light emission signal.

22. The method of claim 21, wherein the method includes selecting a wavelength between approximately 600 and 800 nanometers for the visible light signal.

23. The method of claim 19, wherein the method includes providing an infrared light signal for the light emission signal.

24. The method of claim 23, wherein the method includes selecting a wavelength greater than approximately 800 nanometers for the infrared light signal.

25. The method of claim 19, wherein the hearing aid is a behind-the-ear hearing aid and the method includes placing the optical window on an inside surface of the behind-the-ear hearing aid.

26. The method of claim 19, wherein the hearing aid is one of an in-the-ear hearing aid, an in-the-canal hearing aid and a completely-in-the-canal hearing aid, and in each case, and the method includes placing the optical window on a portion of the hearing aid that is shaped to match the shape of a portion of the concha or inner auditory meatus of the hearing aid user in a complementary fashion.

27. The method of claim 19, wherein the method further comprises placing an light reflecting material over the optical window for performing conventional testing on the hearing aid.
